(19) United States
(12) Patent Application Publication
(10) Pub. No.: US 2015/0244457 A1
(43) Pub. Date: Aug. 27, 2015

(54) Apparatus For Data Communications, Method Of Performing Data Communications

(71) Applicant: ISIS INNOVATION LIMITED, Oxford, Oxfordshire (GB)

(72) Inventors: Dominic Christopher O'Brien, Oxfordshire (GB); Andrew Archibald Ronald Watt, Oxfordshire (GB); Steve Collins, Oxfordshire (GB)

(21) Appl. No.: 14/431,610

(22) PCT Filed: Sep. 26, 2013
(86) PCT No.: PCT/GB2013/052509

§ 371 Date: Mar. 26, 2015

(30) Foreign Application Priority Data
Sep. 27, 2012 (GB) 1217279.7

(51) Int. Cl. H04B 10/11

(52) U.S. Cl. CPC H04B 10/11

(57) ABSTRACT

Apparatus and methods for data communications are disclosed. In a disclosed arrangement, there is provided an apparatus for data communications, comprising: a detector for detecting electromagnetic radiation; a decoder for obtaining information from the detected electromagnetic radiation; and a concentration stage for receiving and concentrating the radiation, prior to detection of the radiation by the detector, the concentration stage comprising a wavelength converting element configured to convert radiation to longer wavelength radiation.

The present invention relates to apparatus and methods for data communications that use optical concentration devices (“optical concentrators”).

Optical concentration refers to the process of receiving light using a relatively large collecting aperture and concentrating that light onto a much smaller area. There are many applications for concentrators, including in free space optical communications. In this case light carries an information signal, and an optical receiver uses a concentrator to collect light from the largest area possible and concentrate it on as small a photo-detector as feasible. This process is desirable because large photo-detectors tend to be more difficult to operate at high data rates than smaller photo-detectors. Conventionally lenses and mirrors are used as optical concentrators.

The amount of optical concentration that can be achieved by these methods is limited due to factors such as the constant radiance theorem and losses. This restricts the extent to which communication efficiency can be improved using optical concentrators.

A further problem is that the geometry of optical concentrators may not be convenient for data communications applications. It is difficult to provide systems having large collecting apertures and/or high concentration factors in a small volume and/or convenient shape.

It is an object of the invention to address at least one of the problems discussed above in relation to the prior art.

According to an aspect of the invention, there is provided an apparatus for data communications, comprising: a detector for detecting electromagnetic radiation; a decoder for obtaining information from the detected electromagnetic radiation; and a concentration stage for receiving and concentrating the radiation, prior to detection of the radiation by the detector, the concentration stage comprising a wavelength converting element configured to convert radiation to longer wavelength radiation.

Thus, a novel configuration for receiving data via electromagnetic radiation is provided. The configuration can be incorporated into a wide range of different devices, with a minimum of visual impact, due to the flexibility in choice of geometry for the wavelength converting element of the concentration stage. In an embodiment, the wavelength converting element has a thickness that is smaller than the length and/or width of the element. In an embodiment, the wavelength converting element is provided in a substantially sheet-like form, for example having a thickness that is at least 10 times, optionally at least 50 times, optionally at least 100 times, smaller than the length and/or width of the element. A large collection area in a relatively small volume device can thus be provided. In an example embodiment, the wavelength converting element is provided in a substantially planar form.

The wavelength conversion to longer wavelengths makes it possible to provide a wider field of view for a given level of gain or, conversely, a higher gain for a given field of view, than otherwise comparable etendue preserving concentrators.

Free space optical communications typically use a limited range of wavelengths for transmission of data, which enables the wavelength converting element to operate efficiently. The wavelength conversion makes it possible to achieve a higher level of concentration than would be possible using only a single wavelength from source to detector, due to the limits of the constant radiance theorem in the case where the wavelength of radiation involved is constant. Increasing the degree of concentration makes it possible for the detector to be made smaller and therefore more efficient, for example faster and/or cheaper.

In an embodiment, the concentration stage is incorporated into the screen of a display device, for example in a portable electronic device such as telephone, Personal Digital Assistant (PDA), tablet pc, etc., or in a non-portable electronic device such as television or computer monitor.

In an embodiment the wavelength converting element and/or confinement structure (where provided) of the concentration stage is/are configured to be substantially transparent to visible light and can thus be incorporated into the screen without interfering with the normal operation of the screen as a display. Preferably, both the incident and converted wavelengths are also invisible. Making the converted light invisible ensures that converted light that escapes from the wavelength converting element is not visible. If this were not the case, such converted light might make the wavelength converting element appear to “glow” and/or otherwise have a negative visual impact.

In an embodiment, an additional concentration stage is provided before the concentration stage comprising the wavelength converting element. Optionally, the additional concentration stage comprises a compound parabolic concentrator. Alternatively or additionally, an additional concentration stage may be provided after the concentration stage comprising the wavelength converting element.

In an embodiment, the detector is formed as an element that is separate from the concentration stage comprising the wavelength converting element and/or from any other concentration stage. However, this is not essential. In other embodiments, the detector may be formed as an integrated component. For example, the detector may be integrated into a concentration stage made from silicon.

In an embodiment, the wavelength converting element comprises a fluorescent dye. Fluorescent dyes are widely available and relatively inexpensive, facilitating cost-effective manufacture and the provision of a wide range of operational characteristics. In many cases, a change in operational characteristics can be implemented simply by changing the composition of the dye in the wavelength converting element.

In an embodiment, the wavelength converting element comprises quantum dot wavelength converters. Quantum dot wavelength converters can provide highly efficient and flexible wavelength conversion.

In an embodiment, the wavelength converting element and/or surrounding confinement structure (where provided) is provided in a flexible form. The flexibility facilitates attachment to or incorporation within a device and/or allows the wavelength converting element and/or confinement structure easily to adopt a curved form. Where the wavelength converting element is required to adopt a substantially curved form, which may disrupt total internal reflection within the wavelength converting element, the use of a confinement structure (for example in the form of a coating) may be particularly desirable to reduce radiation loss. In an embodiment, the wavelength converting element and/or confinement structure is configured so that it/they can be switched between an extended state (e.g. spread out in a flat or planar configuration suitable for collecting light efficiently) and a compact, storage state (e.g. rolled or folded up).

In an example embodiment, the apparatus for data communications is used to allow two portable electronic devices to transmit information optically, over free space, to each other. In another example embodiment, a display device is adapted to use the apparatus for data communications to receive a data signal, for example of a film or the internet, via the screen of the device. In an embodiment the data signal is transmitted via an optical signal emitted using a light source that is also used for domestic lighting, for example a modulated LED light.

According to an aspect of the invention, there is provided a method of performing data communications, comprising: using a concentration stage to receive and concentrate electromagnetic radiation; using a wavelength converting element in the concentration stage to convert radiation to longer wavelength radiation; detecting radiation output by the concentration stage; and decoding the detected radiation in order to obtain information from the detected radiation.

Embodiments of the invention will now be described, by way of example only, with reference to the accompanying drawings in which corresponding reference symbols represent corresponding parts, and in which:

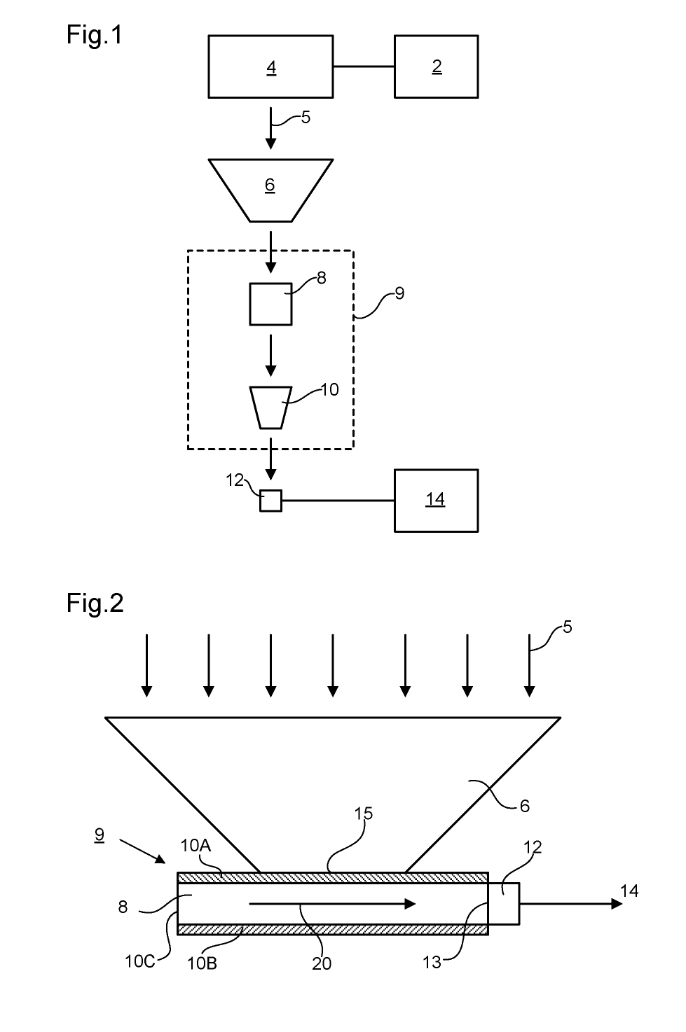

FIG. 1 depicts a data communication system comprising an apparatus for optical concentration having a first concentration stage and second concentration stage, the second concentration stage incorporating a wavelength converting element.

FIG. 2 depicts an apparatus for optical concentration comprising first and second concentration stages, in which the second concentration stage comprises a confinement structure formed of parallel planar dichroic elements containing a wavelength converting element.

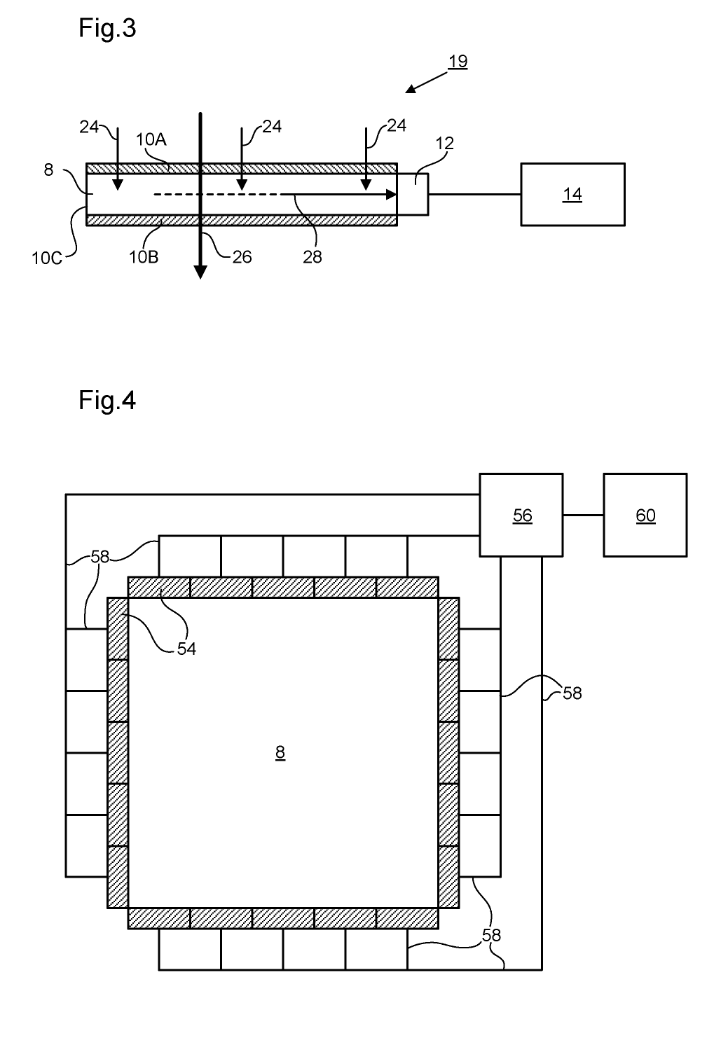

FIG. 3 depicts an apparatus for data communications comprising a single concentration stage that incorporates a wavelength converting element.

FIG. 4 depicts a detector with a plurality of detector elements.

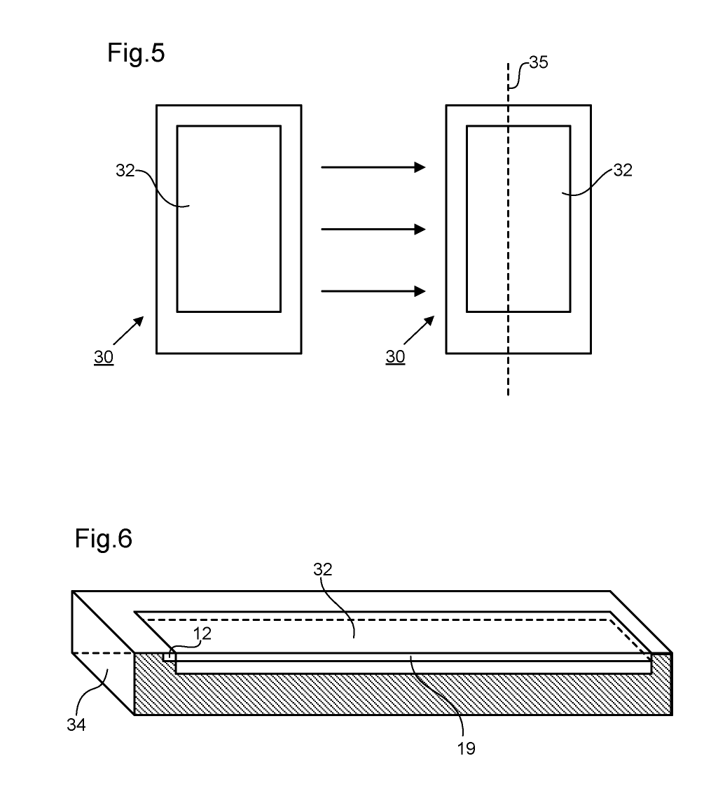

FIG. 5 depicts communication between two portable electronic devices, each comprising a display device that has an apparatus for data communications comprising a concentration stage and wavelength converting element.

FIG. 6 depicts an arrangement in which the wavelength converting element of a concentration stage is built into the screen of a display device.

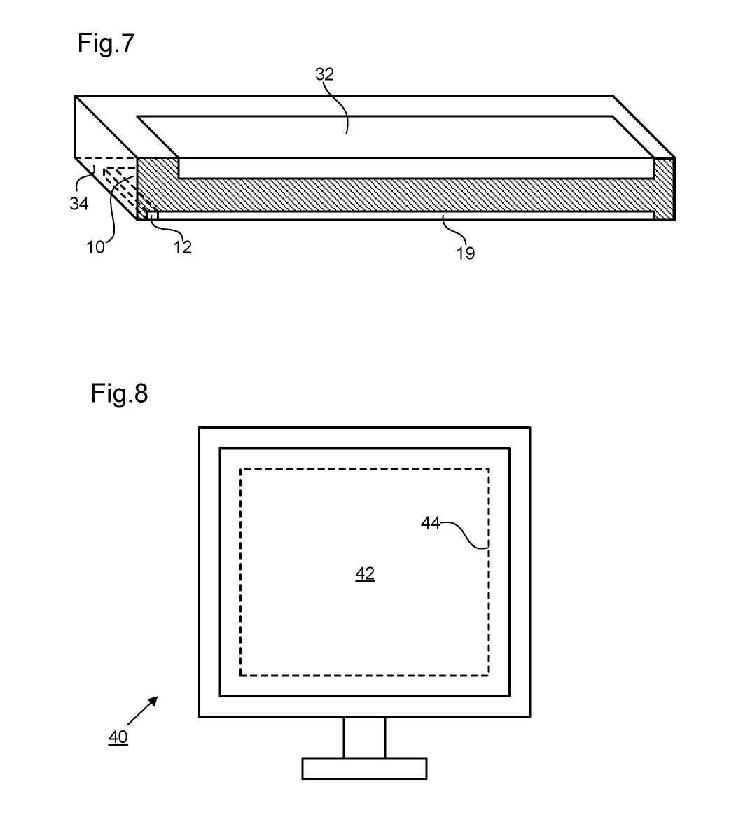

FIG. 7 depicts an arrangement in which a wavelength converting element of a concentration stage is built into the rear side of a display device.

FIG. 8 depicts a television or monitor comprising a display device having an apparatus for data communications comprising a concentration stage and a wavelength converting element, the wavelength converting element having a geometry and size corresponding approximately to that of the screen of the television or monitor.

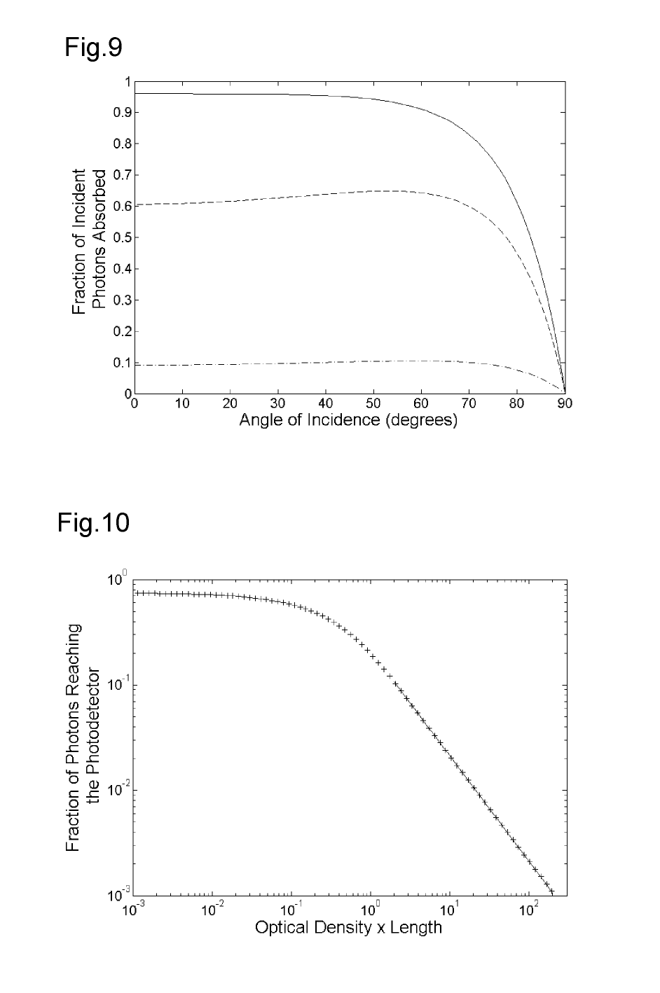

FIG. 9 depicts the product of the transmission coefficient and the probability of absorption for three different optical densities. The solid line is when Oᵢ=10, the dashed line is when Oᵢ=1 and the dotted line is when Oᵢt=0.1.

FIG. 10 depicts the fraction of light emitted within the slab that arrives at a detector placed along one edge of a concentrator as a function of OₑL. The crosses are the calculated points and the solid line has a slope of −1, this being the region in which the total number of photons reaching the edge of the concentrator will become independent of length.

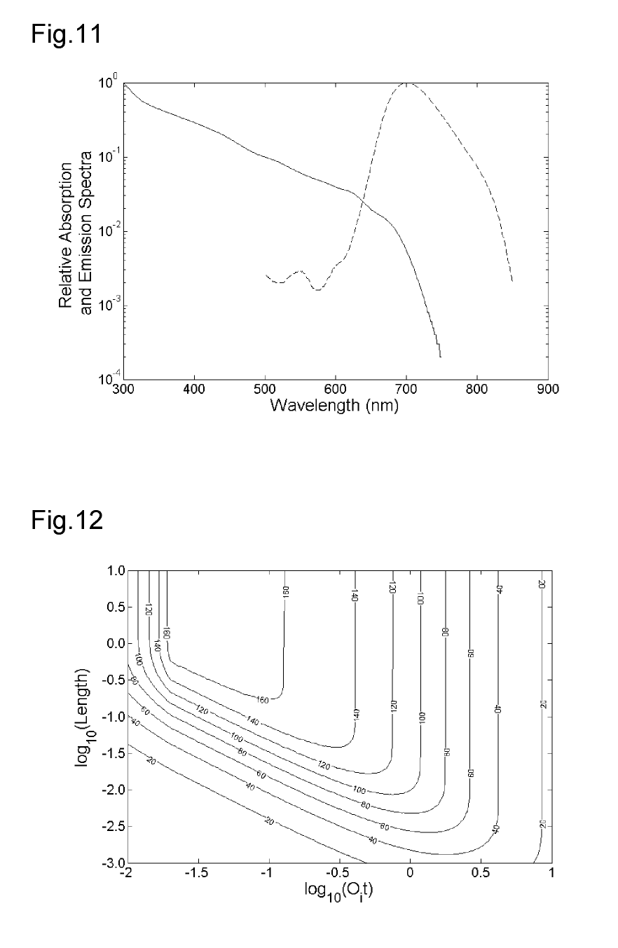

FIG. 11 depicts the relative absorption (solid line) and emission spectra (dashed line) of Qdot® 705 (data downloaded from http://www.fluorophores.tugraz.at/).

FIG. 12 depicts contours of concentrator gain for a 10 μm thick concentrator at different lengths and optical densities at the incident wavelength for Qdot® 705 with substrate absorption coefficients of 2 m⁻¹.

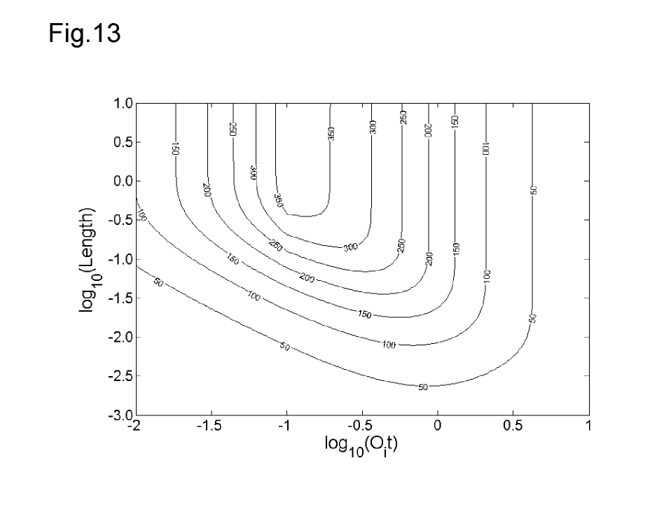

FIG. 13 depicts contours of concentrator gain for a 10 μm thick concentrator at different lengths and optical densities at the incident wavelength for Qdot® 705 with a substrate absorption coefficient of 2 m⁻¹ and with a mirror added behind the concentrator.

As mentioned in the introductory part of the description, optical concentration can be used to reduce the size of photo-detectors required in free space optical communications applications. However, the amount of concentration that can be achieved using conventional methods such as lenses or compound parabolic concentrators is limited by the constant radiance theorem (also known as étendue conservation). The constant radiance theorem holds where the wavelength of light does not change in the optical system in question. However, the inventors have recognised that concentration levels greater than the limits imposed by the constant radiance theorem for a single wavelength of light can be achieved by changing the wavelength of the light during the concentration process. In an embodiment, this is achieved using a “wavelength converting element”. A wavelength converting element absorbs radiation at one wavelength or range of wavelengths and re-emits the radiation at a second wavelength or range of wavelengths that is different to the first. In an embodiment, the conversion involves shifting from a shorter wavelength to a longer wavelength. In an embodiment, the wavelength converting element is configured to have a short response time, for example of 1 microsecond or less, optionally 10 nanoseconds or less, optionally 1 nanosecond or less, in order to facilitate high bandwidth data communications. Examples of wavelength converting elements are described in further detail below.

FIG. 1 illustrates schematically a data communication system based on this principle. According to this arrangement, information to be transmitted by the data communication system is encoded by encoder 2 and provided to a radiation source 4. The radiation source 4 transmits radiation 5 to a first concentration stage 6. The output from the first concentration stage 6 is input to a second concentration stage 9, which comprises a wavelength converting element 8 and means 10 for directing radiation in a concentrated manner towards a detector 12. The output from the detector 12 is provided to a decoder 14 which can retrieve the information that has been transmitted by decoding the received encoded signal.

In the arrangement shown, the wavelength converting element 8 and the means 10 for directing radiation are shown schematically as separate elements. However, as discussed below in respect of a detailed example, the wavelength converting element 8 and means 10 for directing radiation may alternatively be provided in a single unit. In further embodiments, one or more further concentration stages may be provided. In such embodiments, one or more further wavelength converting elements may also be provided, each incorporated into one or more of the further concentration stages. Having a plurality of wavelength converting elements may be useful for example where it is desired for the transmitter to send signals in a plurality of different wavelength bands. In such a scenario each of the wavelength converting elements could be configured to absorb radiation in a different one of the transmitted wavelength bands. Wavelength converting elements that have fluorophores with absorption peaks may be particularly well suited to such embodiments.

In an embodiment, the wavelength converting element is configured to convert radiation to longer wavelength radiation, for example by absorbing radiation at a first wavelength or wavelengths and re-emitting the radiation at a second wavelength or wavelengths that is longer than the first. This process results in the modification of the spectrum of radiation incident on the wavelength converting element in such a way that power is shifted from the first wavelength or wavelengths to the second wavelength or wavelengths.

FIG. 2 depicts an example configuration for an apparatus for optical concentration in further detail. The apparatus for optical concentration depicted comprises a first concentration stage 6 for receiving and concentrating radiation 5 input to the optical concentrator. The optical concentrator also comprises a second concentration stage 9 for receiving radiation output from the first concentration stage 6. The output from the second concentration stage 9 is directed towards a detector 12. The output from the detector 12 is provided to a decoder 14 (not shown).

In the embodiment shown, the first concentration stage 6 comprises a compound parabolic concentrator. In the embodiment shown, the second concentration stage 9 comprises a wavelength converting element 8. Radiation output from the wavelength converting element 8 is directed to a detector 12 by reflection from a confinement structure 10A, 10B and from free (e.g. exposed to the environment) peripheral sides 10C of the wavelength converting element 8. In the embodiment shown, the confinement structure 10A, 10B comprises a pair of planar dichroic elements. The confinement structure 10A, 10B is configured substantially to allow passage of radiation having a wavelength that is suitable for conversion by the wavelength converting element 8 from the outside of the confinement structure 10A, 10B to the inside of the confinement structure 10A, 10B. The confinement structure 10A, 10B is further configured to substantially block passage of radiation (e.g. by reflection) that has been converted by the wavelength converting element 8 from the inside of the confinement structure 10A, 10B to the outside of the confinement structure 10A, 10B (thus “confining” converted radiation within the confinement structure). In an alternative embodiment, the confinement structure 10A, 10B is omitted and radiation emitted by the wavelength converting element 8 is directed to the detector 12 by internal reflection within the wavelength converting element 8. Use of a confinement structure will tend to favour lower losses. Omitting the confinement structure may facilitate manufacture and/or reduce cost.

In the embodiment shown, the detector 12 is arranged along one peripheral side only (the right hand peripheral side in the orientation of FIG. 2) of the second concentration stage 10. However, this is not essential. In other embodiments, the detector 12 may be provided along more than one of the sides. In an embodiment, the detector 12 is provided on all peripheral sides of the second concentration stage 10, for example so as to form a closed loop. Configuring the detector to be present on more than one side may increase the proportion of radiation emitted by the wavelength converting element 8 that is detected. Additionally or alternatively, where the detector 12 comprises a plurality of detector elements, optionally spread around two or more of the peripheral sides, that can independently measure a radiation flux incident on them, the detector 12 can obtain a measure of a spatial distribution of radiation incident on the wavelength converting element (this possibility is discussed in further detail below with reference to FIG. 4).

Where the detector 12 is not provided on all peripheral sides, internal reflection may be sufficient to prevent excessive loss of radiation via uncovered peripheral sides. However, in an embodiment, an additional peripheral reflector may be provided to reduce losses. The peripheral reflector may be a broadband reflector such as a metal mirror. In an embodiment, a dichroic mirror is used as the peripheral detector.

In an embodiment, the re-emission of the wavelength converted radiation within the wavelength converting element 8 happens in all directions and reflections from the surface of the wavelength converting element 8 and/or confinement structure (where provided) are effective to direct the radiation (see arrow 20) towards the detector 12. In an embodiment, the geometry and dimensions of the wavelength converting element 8 and/or confinement structure 10A, 10B determine the size of the surface area 13 on the detector 12 that receives radiation, and therefore determine, at least in part, the final concentration factor achieved. In the particular example shown, the surface area 13 will be determined by the shape of the dichroic elements 10A, 10B (e.g. rectangular), the separation between the dichroic elements 10A, 10B, and the depth (into the page) of the dichroic elements 10A, 10B. The surface area 13 will typically be much smaller than the surface area 15 defining the input to the second concentration stage 10 from the first concentration stage 6. However, the efficiency of the wavelength conversion process, which will depend on the thickness of the wavelength converting element 8, will tend to limit the amount of concentration that can be achieved. In practice, the thickness of the wavelength converting element 8 can be varied until an optimum balance is achieved between reducing the surface area 13 and increasing conversion efficiency.

In an embodiment, the wavelength converting element 8 comprises a quantum dot wavelength converter. In an embodiment, the quantum dot wavelength converter comprises solution processed quantum dots. Solution processed quantum dots are particularly suitable for this application because they have tuneable absorption and emission characteristics, large luminescence quantum yields and Stokes shifts compatible with minimal re-absorption losses. In an embodiment the quantum dot wavelength converter comprises lead chalcogenide quantum dot wavelength converters.

In an alternative embodiment, the wavelength converting element 8 comprises a fluorescent dye.

In an embodiment, the wavelength converting element 8 comprises a support body containing dispersed wavelength converting elements. The dispersed wavelength converting elements may comprise fluorescent dye. Alternatively, the dispersed wavelength converting elements may comprise quantum dot wavelength converters. The support body may comprise one or more of the following: an amorphous polymer, an inorganic glass, a SiO₂-based inorganic glass, an acrylic. In an embodiment, the wavelength converting element 8 and/or support body is/are configured to be substantially transparent to converted radiation so as to reduce or minimize re-absorption losses.

In the embodiment discussed above, the apparatus for optical concentration comprises two concentration stages. However, this is not essential. In an embodiment, an apparatus for optical concentration is provided that has a single concentration stage only. In an embodiment, the single concentration stage has a structure that is identical to the second concentration stage 9 discussed above. The variations and details discussed above with reference to the second concentration stage 9 can be applied to such an embodiment.

FIG. 3 illustrates an example apparatus for data communications that comprises an apparatus for optical concentration having a single concentration stage 19 only. As can be seen, the structure of the single concentration stage 19 is the same as the second concentration stage 9 shown in the embodiment of FIG. 2. In an embodiment, the wavelength converting element 8 and/or confinement structure 10A, 10B (where provided) is/are configured to allow visible light 26 to pass through it/them. In the particular example shown the confinement structure 10A, 10B and/or wavelength converting element 8 is/are arranged to be substantially transparent to visible light, while light outside of the visible spectrum (e.g. infrared light or UV light) 24 can enter the confinement structure 10A, 10B but is subject to wavelength conversion by the wavelength converting element 8. The wavelength converted radiation 28 is subsequently trapped by reflection from the (inner) surface of the wavelength converting element 8 and/or from the confinement structure 10A, 10B and/or from free peripheral surfaces 10C and is directed to a detector 12.

In an embodiment, the light 24 has a wavelength that is shorter than the visible spectrum (e.g. UV) and is converted to light having a wavelength that is longer than the visible spectrum (e.g. infrared), thus involving a large Stokes shift. Alternatively or additionally, the wavelength converting element 8 may be configured to absorb some radiation that is within the visible spectrum. In this case the absorption may be configured to be sufficiently low as to be imperceptible to a user of the device. For example, if the apparatus for optical concentration is integrated into the screen of a display device, the absorption in the visible spectrum may be arranged to be low enough that the performance of the screen is not noticeably affected. Similar considerations apply if the aim is to provide the apparatus for optical concentration as an “invisible” (or nearly invisible) layer on the surface of a device. Absorption and re-emission is preferably at wavelengths outside of the visible spectrum, or predominantly so, or the absorption is at a sufficiently low level that appearance is not affected excessively by the presence of the apparatus.

In an embodiment, the detector 12 comprises at least two detector elements 54. In an embodiment, the at least two detector elements 54 are able independently to measure a radiation flux output from different regions on the surface (e.g. different regions on the peripheral sides) of the wavelength converting element. A schematic top view of such an arrangement is shown in FIG. 4. Smaller detector elements 54 tend to have lower capacitances than larger detector elements, which means they can respond more quickly and therefore deal with higher data rates. Thus, by using a plurality of smaller detector elements 54 in place of a single larger detector element it is possible to sample the same amount of output radiation while improving the bandwidth. In an embodiment, the detector elements 54 comprise single photon detector elements. Single photon detector elements can only detect one photon at a time and there is an intrinsic delay or “dead time” between when the detector detects a photon and when the detector is able to detect a subsequent photon. Using a plurality of smaller photon detectors tends to distribute output photons between different detectors more efficiently and thus reduces limitations in sensitivity and/or speed caused by the dead time of individual detector elements.

In an embodiment, an orientation optimization unit 56 is provided for automatically adjusting the orientation of one or more elements of the data communications apparatus (including for example the orientation of the wavelength converting element 8) to increase the total amount of radiation detected. In an embodiment, the orientation optimization unit 56 is configured to receive signals representing the amount of radiation detected by the detector elements 54 via tracks 58. In an embodiment, the orientation optimization unit 56 monitors changes in the output of the detector elements 54 as a function of changes in the orientation of the wavelength converting element (and/or one or more other elements of one or more concentration stages) and uses a search method based on the monitoring to find an orientation of the wavelength converting element (and/or one or more other elements of one or more concentration stages) that increases the output from the detector elements 54. In an embodiment, the orientation optimization unit 56 provides a signal to a drive unit 60 that is capable of changing the orientation of the wavelength converting element (and/or one or more other elements of one or more concentration stages) according to the signal.

In the embodiment shown, the wavelength converting element 8 is substantially square and five detector elements 54 are arranged along each of the four peripheral sides of the wavelength converting element 8. In other embodiments the wavelength converting element 8 has a different shape and/or a different number of detector elements 54 are provided.

In an embodiment, the wavelength converting element 8 is provided in a relatively flat or “sheet-like” form. Optionally, the thickness of the element 8 is arranged to be smaller, optionally at least 10 times, optionally at least 50 times, optionally at least 100 times, smaller, than any dimension (e.g. width or length) in the plane of the sheet. Such geometry can efficiently be used in conjunction with devices that naturally present relatively large exterior surfaces. In particular, where the wavelength converting element 8 and/or confinement structure 10A, 10B is substantially transparent to visible light, the apparatus can be provided as part of the screen of a display device without affecting the visual appearance and/or performance of the screen. Display devices are used to display information, so that the provision of an alternative or additional means for providing information to the device supporting the display is likely to be desirable.

In an embodiment, a concentration stage of the type shown in FIG. 3 is provided as part of the screen 32 of a portable electronic device 30 such as a personal digital assistant, mobile phone, laptop, tablet pc etc., as shown schematically in FIG. 5. Here, two portable electronic devices 30 are depicted. The two portable electronic devices 30 may communicate with each other by using the display (or any other source of light on the device, such as an LED flash in the case where the portable electronic device is a mobile phone or camera) to send information, as visible or infrared radiation for example, to the other portable electronic device 30. The wavelength converting element 8 and/or confinement structure 10A, 10B may be provided on the screen 32 of the portable electronic device 30. Alternatively or additionally, the wavelength converting element 8 and/or confinement structure 10A, 10B may be provided on a rear side of the device, which typically also has a relatively large planar form suitable for receiving radiation over a relatively large surface area, or on any other suitable surface of the device.

FIG. 6 is a schematic sectional view along line 35 in FIG. 5 showing a concentration stage 19 built into a screen 32 of the portable electronic device 30. FIG. 7 is a schematic sectional view along the line 35 of the embodiment of FIG. 5 showing an alternative arrangement in which the concentration stage 19 is built into a rear surface 34 of the portable electronic device 30.

In general, the concentration stage 19 may be provided in such a manner as to exploit the dimensions and/or geometry of the device into which it is incorporated. This may involve configuring the concentration stage 19 to have the same geometry as the geometry of the screen of a display device, for example. Alternatively or additionally, the concentration stage 19 may be configured as an element having at least one dimension that is the same as a dimension of the screen of a display device, within 25% for example. In an embodiment, the concentration stage 19 comprises a wavelength converting element 8 that is planar and has at least one dimension that is the same as the dimension of the screen of the device within 25% (optionally within 15%, optionally within 5%, optionally within 1%).

In an embodiment, the apparatus for optical concentration/data communications is built into the screen of a display device that is powered completely independently of the apparatus for optical concentration/data communications. In an embodiment, the apparatus for optical concentration/data communications is used to provide some or all of the power required by the display in addition to providing data to the display. For example, excess power from the light providing the data is used to power the display or contribute to powering the display in combination with a separate power source. For example, the display device might consist of a thin sheet of material resembling a piece of paper or poster that might be attached to the wall. Data defining what is to be displayed on the poster can be transmitted to the poster via a light source and the excess power from the data provision can be used to power the display device.

In an embodiment, the wavelength converting element 8 and/or confinement structure 10A, 10B is configured to be switchable between an extended state and a storage state. The extended state provides a relatively large collection aperture and would typically correspond to the normal configuration of the device in use (e.g. when collecting radiation as part of a data communication process). The storage state is more compact and would typically correspond to a storage configuration. In an embodiment, the switching is performed by folding (unfolding) the wavelength converting element and/or confinement structure or by rolling (unrolling) the wavelength converting element and/or confinement structure.

In an embodiment, the wavelength converting element and/or confinement structure is/are configured to be flexible. This may facilitate manufacture, particularly where the wavelength converting element and/or confinement structure is required to have a curved form, and/or may facilitate switching of the wavelength converting element and/or confinement structure between an extended state and a storage stage, in embodiments where this is required.

FIG. 8 is a schematic depiction of a further embodiment in which a television or monitor 40 is provided with a concentration stage 44 having a wavelength converting element incorporated into the screen 42 thereof. In this particular example, the wavelength converting element and/or confinement structure has/have both the same geometry, and two dimensions (length and width) that are within 25% of the corresponding dimensions of the screen of the display device.

In an embodiment, the wavelength converting element 8 is configured to convert UV radiation to visible, infrared or near-infrared radiation. Alternatively or additionally, the wavelength converting element 8 is configured to convert infrared or near-infrared radiation to other infrared or near-infrared radiation. Alternatively or additionally, the wavelength converting element 8 is configured to convert visible radiation to other visible radiation or infrared or near-infrared. In an embodiment, the wavelength converting element 8 is configured to absorb radiation at approximately 475 nm and re-emit at approximately 600 nm. In such a system, a confinement structure may be provided that is configured substantially to pass radiation having a wavelength of approximately 475 nm and to trap radiation having a wavelength of approximately 600 nm. Such a system may be implemented using the dye Ru(BPY)3 for example. Alternatively or additionally, Qdot® 705 (Life Technologies Corporation) quantum dots may be used (see below).

### FURTHER DESCRIPTION OF DETAILED EXAMPLES

In the description above, embodiments have been described, amongst others, that comprise a single concentration stage 19 having a wavelength converting element 8 (see for example FIG. 3). In the discussion below, concentration stages 19 of this general type, which may also be referred to simply as “concentrators 19”, are discussed in further detail and their performance modelled. In the examples discussed the wavelength converting elements 8 operate on the basis of fluorescence, so reference is made to “fluorophores” as the fluorescent media.

The operation of such concentrators 19 may depend upon the following sequence of processes. The first process is transmission of the incident light into the concentrator 19. Once in the concentrator 19 the incident light is absorbed by the fluorophore before being emitted with a quantum yield Q_{y}. Finally the isotropically distributed emitted light is desirably retained within the concentrator 19 by total internal reflection until it reaches a photodetector 12, provided for example along one edge of the concentrator 19. The field of view is determined by the angle of incident dependence of the probability that the incident light will be transmitted into the concentrator 19 and then absorbed. These two processes mean that the fraction of light that will be absorbed in a concentrator of thickness, t, when the angle of incidence is θᵢ is

Fᵢ(θᵢ)=T(θᵢ)(1−exp(−Oᵢt/cos(θₜ))) (1)

where θₜ is the transmission angle for the light and Oᵢ is the optical density of the concentrator 19 at the wavelength of the incident light. The results in FIG. 9 show that for each optical density the fraction of incident light that is absorbed is insensitive to variations in the angle of incidence of the light for angles less than 60° for higher optical densities and 75° for lower optical densities. These concentrators 19 can therefore have a wide field of view.

The gain of a fluorescence based concentrator 19 with a photodetector 12 placed along one edge is determined by a sequence of physical processes. In particular, if the probability of transmission into a concentrator 19 is T, the probability of an incident photon being absorbed is Fᵢ and the probability of an emitted photon reaching the receiver is Fᵣ then for a concentrator of length L and thickness t the gain is

G=T×Fᵢ×Q_{y}×Fᵣ×L/t (2)

where Q_{y} is the quantum yield. If reabsorption of the emitted photons is negligible, Fᵣ=1, then equation 2 suggests that by simply making the concentrator 19 longer it will be possible to achieve an arbitrarily large gain. This consideration demonstrates that reabsorption will be the process which limits the maximum gain that can be achieved with this form of concentrator 19.

When re-absorption of the emitted photons is significant the probability that a photon will reach the detector 12 will depend upon the distance that a photon has to travel to reach the detector 12. This means that the probability that a photon will reach the detector 12, will depend upon both the location within the concentrator 19 from which the photon is emitted and the direction in which it initially travels.

The following example analysis applies to an example rectangular concentrator 19 which has mirrors along three edges and a photodetector 12 on the fourth edge. In addition it is assumed that any reabsorbed photons are unable to reach the detector 12. Then if the photon is emitted at angles θ and φ from a point that is a perpendicular distance y from the receiver and Oₑ is the effective optical density of the concentrator 19 for photons at the emitted wavelength, then the fraction of emitted photons that will reach a detector 12 along one edge of the concentrator 19 is given by

$${F}_{r} ( {O}_{e} , L ) = \frac{1}{π L} {\int }_{0}^{L} {\int }_{0}^{π / 2} {\int }_{{θ}_{c}}^{π / 2} ( exp [ - {O}_{e} y / sin θsin φ ] ) sin θ d y d φ d θ + \frac{1}{π L} {\int }_{0}^{L} {\int }_{0}^{π / 2} {\int }_{{θ}_{c}}^{π / 2} ( exp [ - {O}_{e} ( 2 L - y ) / sin θ sin φ ] ) sin θ d y d φ d θ \qquad ( 3 )$$

(J. S. Batchelder, A. H. Zewail and T. Cole ‘Luminescent solar concentrators. 1: Theory of operation and techniques for performance evaluation’, Applied Optics 18 (18) 3090-3110 (1979)).

The limits of these integrals mean that if Oₑ=0 this equation reduces to the probability of being retained by total internal reflection, which for glass or plastics is approximately 0.75. The results of evaluating this integral, FIG. 10, show that reabsorption is only negligible when OₑL<0.1. For a particular value of Oₑ, if a concentrator 19 is longer than this critical length then the fraction of emitted photons that reach the detector 12 starts to reduce. Once OₑL>1.0 the fraction of photons that reach the detector 12 is proportional to 1/L, which means that the total number of photons reaching the detector 12 is independent of L once it is larger than this critical value. This means that for a particular optical density Oₑ there is no advantage in using a concentrator 19 longer than 1/Oₑ for the particular geometry described (with mirrors along three edges and a detector along the fourth edge). However, for longer geometries it may be advantageous to replace one or more of the mirrors with a detector, particularly the mirror opposite to the existing detector.

In an embodiment, the concentration of fluorophore in the concentrator 19 is determined by balancing the desire to absorb incident light with the need to limit the effect of reabsorption. The results in FIG. 9 suggest that the probability of absorption can be approximated using the equation for absorption at normal incidence. For an optical density for the incident light, Oᵢ, and thickness t this is

Fᵢ=(1−exp(−Oᵢt)) (4)

As expected the fraction of incident light absorbed increases with the optical density, however for a particular fluorophore increasing Oᵢ will also increase reabsorption. Based on this insight, in an embodiment, the strategy of increasing the concentration of the fluorophore until it reaches the value that maximises the gradient dFᵢ/dOᵢ is adopted. In accordance with this strategy, in an embodiment Oᵢ=1/t is selected, which gives Fᵢ≈0.6. Preferably, the length of the concentrator 19 is then L=1/Oₑ, which gives Fᵣ=0.2. Since almost all the incident light is transmitted into the concentrator 19 then for L/t=Oᵢ/Oₑ, the concentrator gain is

G≈0.12×Q_{y}×Oᵢ/Oₑ (5)

When selecting a fluorophore for this application an important combination of materials parameters is therefore Q_{y}×Oᵢ/Oₑ.

A survey of the absorption coefficient and emission spectra of fluorophores suggest that it possible to obtain fluorophores in which the ratio Oᵢ/Oₑ is larger than 10³. However, many of these fluorophores have lifetimes longer than 1 μs, which will limit the maximum modulation frequency in any communications system. In contrast it has been reported (Novak, S., Scarpantonio, L., Novak, J., Dai Prè, M., Martucci, A., Musgraves, J. D., McClenaghan, N. D., Richardson, K. 2013 Optical Materials Express 3 (6), pp. 729-738) that quantum dots with a CdSe core and a ZnS shell can have a lifetime of less than 1 ns. Furthermore, the optical characteristics of these quantum dots can be varied by changing the size of the core and several types of CdSe based quantum dots with ZnS shells are sold commercially. One type of quantum dot for which data is available which has promising absorption and emission characteristics are the Qdot® 705 (Life Technologies Corporation) quantum dots. Their properties, FIG. 11, suggest an optical density at 300 nm that is approximately 200 times the optical density at the peak emitted wavelength. Furthermore, this material has a quantum yield of 80% (Min-Kyung So, Chenjie Xu, Andreas M Loening, Sanjiv S Gambhir and Jianghong Rao ‘Self-illuminating quantum dot conjugates for in vivo imaging’ Nature Biotechnology 24(3) 339-343 (2006)), which means that the concentrator gain estimated using equation 5 is approximately 20. This is seven times the gain of an etendue conserving concentrator with a comparable field of view.

As shown in FIG. 11, the absorption coefficient of real fluorophores varies with wavelength. This means that the fraction of emitted photons that reach the detector 12 will depend critically upon wavelength. If the probability distribution of emitted wavelengths is P(λ) the average fraction of emitted photons that will reach the detector 12 is given by:

F̅ᵣ=∫P(λ)Fᵣ(Oₑ(λ),L)dλ (6)

This integral can only be evaluated if the optical density, Oₑ(λ), is known for all emitted wavelengths. However, the data in FIG. 11 suggests that re-absorption by Qdot® 705 is too weak to be considered significant for existing applications for wavelengths longer than 750 nm. The performance of a concentrator 19 containing Qdot® 705 has therefore been estimated assuming that for wavelengths longer than 750 nm the absorption coefficient is approximately 2×10⁻⁴ times the absorption coefficient at 300 nm. In some situations this might make the optical density of the fluorophore at the emission wavelengths less than the optical density of the substrate. The optical density of glass depends upon both wavelength and glass composition (G. W. C Kaye and T. H. Laby ‘Tables of Physical and Chemical Constants and Some Mathematical Functions’ 14^{th} Edition Longman London 1973), but it is typically between 2 m⁻¹ and 0.2 m⁻¹. The effect of absorption by the substrate has therefore been modelled by ensuring that the optical density for reabsorption is never less than 2 m⁻¹ in most calculations or 0.2 m⁻¹ in other calculations.

Typical results of a model which takes into account the quantum yield of Qdot® 705, the optical density of a substrate and the data in FIG. 11 are shown in FIG. 12. These results show that as expected t=1/Oᵢ is a sensible combination of concentrator parameters, particularly when the maximum length of the concentrator 19 is restricted. However, this more accurate model shows that the wavelength dependence of the reabsorption process means that the gain of the concentrator 19 is higher than the simple estimate obtained using equation 5. In particular the estimated gain for a 10 μm thick, 30 cm long concentrator 19 can be as high as 160.

The optical densities required in these thin concentrators 19 and the absorption characteristics of Qdot® 705 mean that, except for the longest concentrators 19 with the lowest optical densities, the effect of reducing the substrate absorption to 0.2 m⁻¹ is negligible. However, a significant amount of light will be transmitted through the concentrator 19 and so its gain can be improved by using a mirror to reflect transmitted light back into the concentrator 19. As shown in FIG. 13 using a mirror will approximately double the gain of a 30 cm long concentrator 19. Alternatively, it is possible to achieve gains of approximately 150 for a 3 cm long concentrator 19. This is approximately 50 times larger than the maximum gain of an etendue preserving concentrator with a comparable field of view.

1-38. (canceled)

39. An apparatus for data communications, comprising:
a detector for detecting electromagnetic radiation;
a decoder for obtaining information from the detected electromagnetic radiation; and
a concentration stage for receiving and concentrating the radiation, prior to detection of the radiation by the detector, the concentration stage comprising a wavelength converting element configured to convert radiation to longer wavelength radiation.

40. An apparatus according to claim 39, wherein the concentration stage comprising the wavelength converting element further comprises a confinement structure that is configured substantially to allow passage of radiation having a wavelength suitable for conversion by the wavelength converting element from the outside of the confinement structure to the inside of the confinement structure, and substantially to block passage of radiation that has been converted by the wavelength converting element from the inside of the confinement structure to the outside of the confinement structure.

41. An apparatus according to claim 40, wherein:
the wavelength converting element is located within the confinement structure.

42. An apparatus according to claim 41, wherein the confinement structure is configured to concentrate radiation towards the detector.

43. An apparatus according to claim 40, wherein the confinement structure comprises two substantially planar elements and the wavelength converting element is located in between the two substantially planar elements.

44. An apparatus according to claim 44, wherein one or both of the substantially planar elements is/are dichroic.

45. An apparatus according to claim 40, wherein the confinement structure is substantially transparent to visible light.

46. An apparatus according to claim 39, further comprising:
one or more further concentration stages; and
one or more further wavelength converting elements incorporated into one or more of the further concentration stages.

47. An apparatus according to claim 39, wherein the wavelength converting element is configured to be switchable between an extended state in which the wavelength converting element presents a large collecting aperture and a storage state in which the wavelength converting element presents a smaller collecting aperture or substantially no collecting aperture.

48. An apparatus according to claim 39, further comprising:
an additional concentration stage positioned before said concentration stage and configured to receive electromagnetic radiation and concentrate the radiation.

49. An apparatus according to claim 39, wherein the detector comprises at least two detector elements.

50. An apparatus according to claim 49, wherein the at least two detector elements are able independently to measure a radiation flux output from different regions on the surface of the wavelength converting element.

51. An apparatus according to claim 39, further comprising an orientation optimization unit configured to increase the amount of radiation detected by the detector by adjusting the orientation of the wavelength converting element.

52. An apparatus according to claim 39, wherein the wavelength converting element comprises a support body with wavelength converting elements dispersed therein.

53. An apparatus according to claim 39, wherein the wavelength converting element comprises a quantum dot wavelength converter.

54. An apparatus according to claim 39, wherein the wavelength converting element comprises a fluorescent dye.

55. A display device comprising an apparatus according to claim 30, wherein the wavelength converting element is incorporated into a screen of the display device.

56. A portable electronic device, television or monitor comprising a display device according to claim 55, wherein the wavelength converting element is incorporated into an exterior side opposite to the screen of the display device.

57. A method of performing data communications, comprising:
using a concentration stage to receive and concentrate electromagnetic radiation;
using a wavelength converting element in the concentration stage to convert radiation to longer wavelength radiation;
detecting radiation output by the concentration stage; and
decoding the detected radiation in order to obtain information from the detected radiation.

58. A method according to claim 57, further comprising:
using an additional concentration stage to concentrate radiation received by the additional concentration stage, wherein said concentration stage is used to concentrate radiation output from the additional concentration stage.
